(19) United States
(12) Patent Application Publication
(10) Pub. No.: US 2013/0298575 A1
(43) Pub. Date: Nov. 14, 2013

(54) REMOTE MONITORING OF A TRANSPORT REFRIGERATION SYSTEM

(71) Applicant: THERMO KING CORPORATION, Minneapolis, MN (US)

(72) Inventors: Mike Stark, Redding, CA (US); Arlo Eslinger, Kent, WA (US); Randall Scott Burnham, St. Michael, MN (US)

(73) Assignee: THERMO KING CORPORATION, Minneapolis, MN (US)

(21) Appl. No.: 13/890,583

(22) Filed: May 9, 2013

Related U.S. Application Data
(60) Provisional application No. 61/644,926, filed on May 9, 2012.

(51) Int. Cl. F25D 29/00; H02P 9/02

(52) U.S. Cl. CPC F25D 29/003; H02P 9/02
USPC 62/56; 62/125; 290/7

(57) ABSTRACT

Systems and methods for remote monitoring of a transport refrigeration system are provided. In one embodiment, a transport refrigeration system (“TRS”) is provided that includes a transport refrigeration unit (“TRU”) and a generator set (“genset”). The TRU includes a refrigeration circuit and a TRS controller. The genset includes a power generator a genset controller, a TRU remote monitoring device configured to obtain TRU telemetry data and a genset remote monitoring device configured to obtain genset telemetry data. The TRS genset is configured to send the TRS telemetry data to an external server.

The embodiments disclosed herein relate generally to a transport refrigeration system (“TRS”). More particularly, the embodiments relate to remote monitoring of a TRS.

### BACKGROUND

Existing transport refrigeration systems are used to cool containers, trailers, and other similar transport units (typically referred to as a “refrigerated transport unit” or “reefer”). Modern refrigerated transport units may be efficiently stacked for shipment by ship, rail or truck. When cargo in the container includes perishable products (e.g., food product, flowers, etc.), the temperature of the refrigerated transport unit must be controlled to limit loss of the cargo during shipment. Typically, a TRS generator set (“genset”) is connected to the refrigerated transport unit in order to provide suitable electrical power to maintain the temperature within the refrigerated transport unit.

### SUMMARY

The embodiments described herein are directed to a TRS. In particular, the embodiments described herein are directed to remote monitoring of a TRS.

The embodiments described herein allow TRS telemetry data (including, for example, TRU telemetry data and TRS generator set (“genset”) telemetry data) to be monitored and stored in a TRS genset. Also, the embodiments described herein allow the TRS genset to transmit the TRS telemetry data to an external server that can be accessed by a user via, for example, a website to allow a user to monitor the geographical location of a transport unit and conditions of the transport unit and cargo within the transport unit.

Further, the embodiments described herein allow TRU telemetry data to be received by and stored in the TRS genset without the need for equipping the TRU with a wireless communication module to communicate with an external server. Accordingly, a TRU is not required to include a remote monitoring device or a long range communications device, such as, for example, a powerline communication device. Thus, the embodiments described herein can save customers the expense of equipping both the TRU and the TRS genset with a remote monitoring device.

Also, the embodiments described herein provide enhanced control between the TRU and the TRS genset. Further, the embodiments described herein provide a cost effective method of correlating data between the TRS genset and the TRU.

In some embodiments, TRS telemetry data is sent to the TRS genset via a wired connection. In other embodiments, TRS telemetry data is sent to the TRS genset via a wireless connection.

Moreover, in the embodiments described herein 1-way or 2-way communication between a TRU and a TRS genset. In particular, a remote monitoring device is included in the TRS genset for remote monitoring of both the TRU and the TRS genset. A temporary interconnection (wired or wireless) can be established in between the remote monitoring device and the TRU in order to establish direct communication with the TRS controller.

In one embodiment, a TRS is provided that includes a TRU and a TRS generator set genset. The TRU includes a refrigeration circuit and a TRS controller. The TRU includes a refrigeration circuit and a TRS controller. The genset includes a power generator a genset controller, a TRU remote monitoring device configured to obtain TRU telemetry data and a genset remote monitoring device configured to obtain genset telemetry data. The TRS genset is configured to send the TRS telemetry data to an external server

Other aspects of the invention will become apparent by consideration of the detailed description and accompanying drawings.

### BRIEF DESCRIPTION OF THE DRAWINGS

Referring now to the drawings in which like reference numbers represent corresponding parts throughout.

FIG. 1 illustrates a side view of an embodiment of a temperature controlled container with a transport refrigeration system, according to one embodiment.

FIG. 2 illustrates a block diagram of an embodiment of a TRS remote monitoring system, according to one embodiment.

### DETAILED DESCRIPTION

The embodiments described herein are directed to a transport refrigeration system (“TRS”). More particularly, the embodiments relate to remote monitoring device of a TRS.

In many instances, large customers may have upwards of 50,000 transport refrigeration units (“TRU”) and may only have 5,000 TRS generator sets (“gensets”). The embodiments described herein allow TRS telemetry data including, for example, TRU telemetry data and TRS genset data, to be transmitted directly to a TRS genset without having to equip the TRU with a remote monitoring device or a long range communications device, such as, for example, a powerline communication device. Accordingly, the embodiments described herein can save customers the expense of equipping both the TRU and the TRS genset with a remote monitoring device.

TRU telemetry data can include, for example, transport unit temperature data, ambient temperature data, humidity level data within the transport unit, humidity level data outside of the transport unit, TRS set-point data, TRS alarm notification data, etc. obtained by the TRU. Genset telemetry data can include, for example, geographical location data of the genset (and accordingly the transport unit), fuel level data of the TRS genset, engine speed data of an engine of the genset, alarm notification data of the TRS genset, operating time data of the TRS genset, etc.

Also, the embodiments described herein provide enhanced control between the TRU and the TRS genset. Further, the embodiments described herein provide a cost effective method of correlating data between the TRS genset and the TRU.

In some embodiments, TRU telemetry data is sent to the TRS genset via a wired connection. In other embodiments, TRS telemetry data is sent to the TRS genset via a wireless connection.

References are made to the accompanying drawings that form a part hereof, and in which is shown by way of illustration of the embodiments in which the methods and systems described herein may be practiced. The term “refrigerated transport unit” generally refers to, for example, a temperature controlled trailer, container, or other type of transport unit, etc. The term “transport refrigeration system” refers to a refrigeration system for controlling the refrigeration of an in internal space of the refrigerated transport unit. The term “TRS controller” refers to an electronic device that is configured to manage, command, direct and regulate the behavior of one or more TRS refrigeration components (e.g., an evaporator, a blower, a heat exchanger, etc.), a genset, etc.

It will be appreciated that the embodiments described herein may be used in any suitable temperature controlled apparatus such as a ship board container, an air cargo cabin, an over the road truck cabin, etc. The transport refrigeration system may be a vapor-compressor type refrigeration system, or any other suitable refrigeration systems that can use refrigerant, cold plate technology, etc.

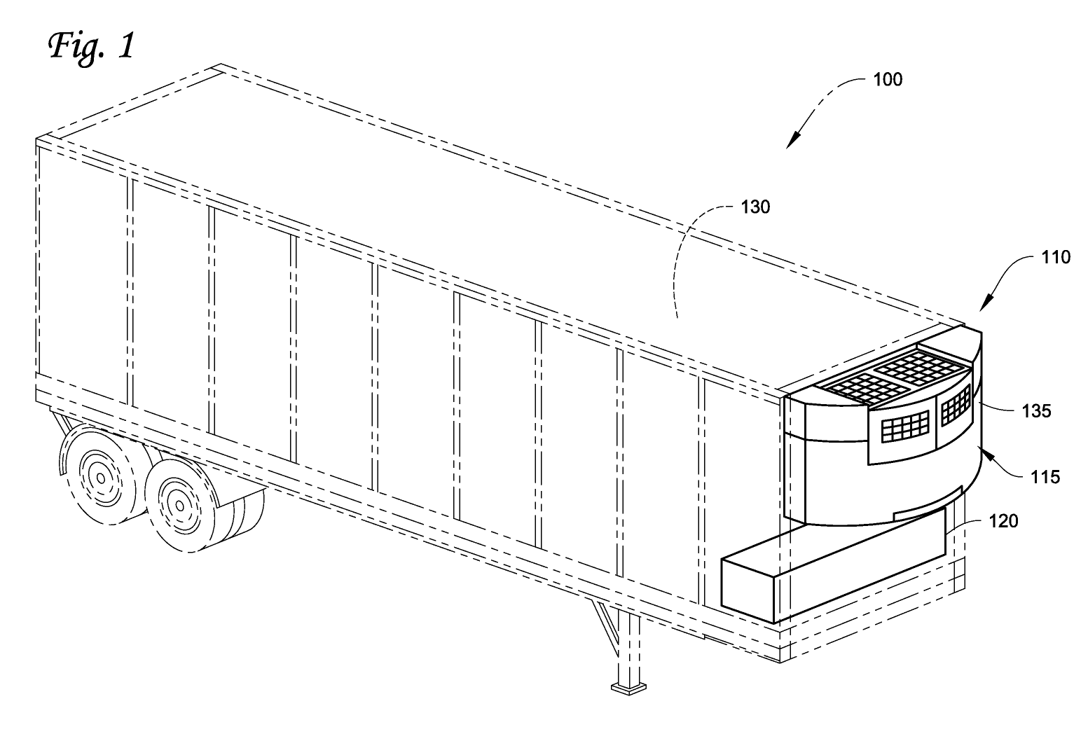

FIG. 1 illustrates a side view of a temperature controlled container unit 100 with a TRS 110 that includes a TRU 115 connected to a TRS genset 120. The container unit 100 can be disposed on a ship, on a train or a truck. The TRU 115 is installed on a side wall of the container unit 100. The TRS 110 is configured to transfer heat between an internal space 130 and the outside environment. In some embodiments, the TRS 110 is a multi-zone system in which different zones or areas of the internal space 130 are controlled to meet different refrigeration requirements based on the cargo stored in the particular zone.

As shown in FIG. 1, the TRU 115 is positioned adjacent to a front side of the transport unit 100 and is enclosed in a housing 135. The TRU 115 is in communication with the space 130 and controls the temperature in the space 130. The TRU 115 includes a TRS Controller (not shown) and a closed refrigerant circuit (not shown). The TRS Controller controls the refrigeration circuit to obtain various operating conditions (e.g., temperature, humidity, etc.) of the space 130, obtains TRU telemetry data, and is powered by the generator set 120. The closed refrigerant circuit regulates various operating conditions (e.g., temperature, humidity, etc.) of the space 130 based on instructions received from the TRS controller. The refrigeration circuit can include, for example, an Electronic Throttle Valve (ETV), a compressor coupled to a condenser and an evaporator that cools the space 130 and the perishable cargo.

The genset 120 generally includes an engine (not shown), a fuel container (not shown) and a generator (not shown). The engine may be an internal combustion engine (e.g., diesel engine, etc.) that may generally have a cooling system (e.g., water or liquid coolant system), an oil lubrication system, an air filtration system (not shown), etc. The air filtration system filters air directed into a combustion chamber (not shown) of the engine. The fuel container is in fluid communication with the engine to deliver a supply of fuel to the engine. In some embodiments the engine is not specifically configured for the TRS 110, but can be a non-industrial engine such as, for example, an automotive engine. The genset 120 also includes a genset controller (not shown) and a remote monitoring device (not shown).

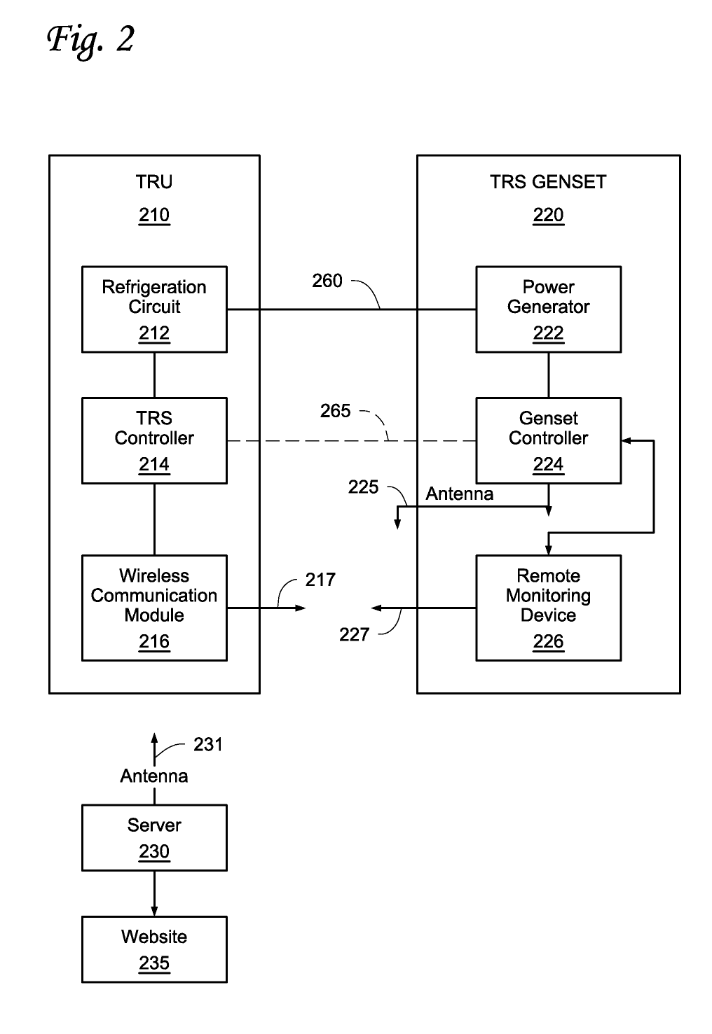

FIG. 2 illustrates a block diagram of one embodiment of a TRS remote monitoring system 200. The system 200 includes a TRU 210, a TRS genset 220 and an external server 250. The TRU 210 is configured to monitor and regulate various operating conditions (e.g., temperature, humidity, etc.) of an interior space of a transport unit connected to the TRU 210. The TRS genset 220 is configured to provide power to the TRU 210 via a power link 260 in order to maintain a desired temperature in an interior space of a TRS transport unit (not shown). That is, the TRS genset 220 is configured to provide power to the TRU 210 in order to, for example, allow the TRU 210 to regulate various operating conditions (e.g., temperature, humidity, etc.) of the interior space of the TRS transport unit. The external server 250 is configured to retrieve TRS telemetry data from the TRS genset 210 and provide the TRS telemetry data to a user via, for example, a website.

The TRU 210 includes a refrigeration circuit 212, a TRS controller 214 and a wireless communication module 216 with a short range communication link 218. The TRS controller 214 is configured to control the refrigeration circuit 212 to obtain various operating conditions (e.g., temperature, humidity, etc.) of an interior space of a transport unit, obtain TRU telemetry data, and is powered by the TRS genset 220. The refrigeration circuit 212 can include, for example, a condenser, a compressor coupled to the condenser, an evaporator and an Electronic Throttle Valve (ETV) that work together to cool the interior space of the transport unit based on instructions received from the TRS controller 212. The wireless communication module 216 is configured to allow the TRU 220 to communicate directly with the TRS genset 220 via the short range communication link 218.

The TRS genset 220 includes a power generator 225, a TRU remote monitoring device 230, a genset remote monitoring device 235, and a genset controller 240.

The power generator 225 is configured to generate power for powering components of the TRU 210 including, for example, the refrigeration circuit 212, the TRS controller 214, and the wireless communication module 216. The power generator 225 generally includes an engine (not shown), a fuel container (not shown) and a generator (not shown). The engine may be an internal combustion engine (e.g., diesel engine, etc.) that may generally have a cooling system (e.g., water or liquid coolant system), an oil lubrication system, an air filtration system (not shown), etc. The air filtration system filters air directed into a combustion chamber (not shown) of the engine. The fuel container is in fluid communication with the engine to deliver a supply of fuel to the engine. In some embodiments the engine is not specifically configured for the TRS, but can be a non-industrial engine such as, for example, an automotive engine.

The TRU remote monitoring device 230 is configured to receive TRU telemetry data from the TRS controller 214. In some embodiments, the TRU remote monitoring device 230 is configured to receive TRU telemetry data from the wireless communication module 216 via a short range communication link 232. In other embodiments, the TRU remote monitoring device 230 can be directly coupled to the TRS controller 214 via an optional communication link 265 to receive TRU telemetry data from the TRU 210. In some embodiments, the optional communication link 265 is powerline communication link. Also, in some embodiments, the TRU remote monitoring device 230 optionally includes a long range communication link 234 that can communicate TRU telemetry data to the external server 250. The long range communication link 250 can also be configured to communicate with a satellite to receive global positioning system (“GPS”) data regarding the location of the TRS genset 220 (and thus the location of the transport unit).

The genset remote monitoring device 235 is directly coupled to the TRU remote monitoring device 230 and can be configured to combine genset telemetry data with TRU telemetry data to obtain TRS telemetry data that can be communicated to the external server 250 via the long range communication link 238.

The genset remote monitoring device 235 is configured to obtain genset telemetry data of the TRS genset 220. In some embodiments, the genset remote monitoring device 235 obtains genset telemetry data from the genset controller 240. The genset remote monitoring device 235 includes a short range communication link 236 that can be configured to communicate with the TRU 210. Also, in some embodiments, the genset remote monitoring device 235 optionally includes a long range communication link 238 that can communicate genset telemetry data to the external server 250. The long range communication link 238 can also be configured to communicate with a satellite to receive global positioning system (“GPS”) data regarding the location of the TRS genset 220 (and thus the location of the transport unit).

The genset controller 240 is configured to control the power generator 225, the TRU remote monitoring device 230 and the genset remote monitoring device 235. The genset remote monitoring device 235 includes a short range communication link 242 that can be configured to communicate with the TRU 210. Also, in some embodiments, the genset controller 240 optionally includes a long range communication link 244 that can communicate with the external server 250. The long range communication link 244 can configured to communicate with a satellite to receive global positioning system (“GPS”) data regarding the location of the TRS genset 220 (and thus the location of the transport unit).

The genset remote monitoring device 235 is directly coupled to the TRU remote monitoring device 230. Also, the genset controller 240 is directly coupled to the power generator 225, the TRU remote monitoring device 230 and the genset remote monitoring device 235. In some embodiments, the TRU remote monitoring device 230 can be configured to combine genset telemetry data with TRU telemetry data to obtain TRS telemetry data that can be communicated to the external server 250 via the long range communication link 234. In other embodiments, the genset remote monitoring device 235 can be configured to combine genset telemetry data with TRU telemetry data to obtain TRS telemetry data that can be communicated to the external server 250 via the long range communication link 238. In yet some other embodiments, the genset controller 240 can be configured to combine genset telemetry data with TRU telemetry data to obtain TRS telemetry data that can be communicated to the external server 250 via the long range communication link 244.

The external server 250 includes a long range communication link 252 and can be accessed by a user via a website 255. The external server 250 is configured to receive TRS telemetry data from the TRS genset 220 via the long range communication link 252 and provide the TRS telemetry data to a user via the website 235. In some embodiments, the external server 250 receives TRU telemetry data from the TRU remote monitoring device 230 and genset telemetry data from the genset remote monitoring device 235. In other embodiments, the external server 250 receives TRS telemetry data from one of the TRU remote monitoring device 230, the genset remote monitoring device 235 or the genset controller 240.

It will be appreciated that in other embodiments the external server 250 can provide a user access to the TRS telemetry data in other forms other than a website such as, for example, a computer application, etc.

In some embodiments, a user, via the website 255, can send commands for controlling the TRS. The external server 250 can be configured to send the user commands to one of the long range communication links 234, 238, 244 of the TRS genset 220 via the long range communication link 252. The commands sent from the external server 250 can be used by the genset controller 220 or the TRS controller 214 to control conditions of the TRS.

In some embodiments, the short range communication links 218, 232, 236, 242 can be configured to receive and transmit data via a short range wireless protocol such as, for example, Zigbee, Bluetooth, etc.

In some embodiments, the long range communication links 218, 234, 238, 244, 252 are configured to transmit and receive data over long distances such as, for example, via a mobile cellular network, a satellite, etc.

### Aspects:

It is noted that any of aspects 1-8 below can be combined with any of aspects 9-16 and any of aspects 17-20. Also, any of aspects 9-16 can be combined with any of aspects 17-20.

1. A remote monitoring system for a transport refrigeration system of a refrigerated transport unit comprising:

a transport refrigeration unit that includes:
a refrigeration circuit configured to cool an interior space of the refrigerated transport unit, and
a transport refrigeration system controller configured to control the refrigeration circuit and to obtain transport refrigeration unit telemetry data; and the transport refrigeration system generator set includes:
a power generator configured to generate power and provide said power to the transport refrigeration unit, and
a generator set controller configured to control the power generator;
   wherein the transport refrigeration system generator set is configured to receive transport refrigeration unit telemetry data sent from the transport refrigeration system controller.
   2. The remote monitoring system of aspect 1, wherein the generator set controller is configured to communicate the transport refrigeration unit telemetry data to an external server.
   3. The remote monitoring system of aspects 1-2, wherein the transport refrigeration system controller is directly coupled to the transport refrigeration system generator set via a powerline communication link, and

the transport refrigeration system controller is configured to send the transport refrigeration unit telemetry data to the transport refrigeration system generator set via the powerline communication link.

4. The remote monitoring system of aspects 1-3, wherein the transport refrigeration unit further includes a wireless communication module coupled to the transport refrigeration system controller, and

the transport refrigeration system controller is configured to send the transport refrigeration unit telemetry data to the transport refrigeration system generator set via the wireless communication module.

5. The remote monitoring system of aspects 1-4, wherein the transport refrigeration unit telemetry data includes one or more of: refrigerated transport unit temperature data; ambient temperature data; humidity level data within the refrigerated transport unit; humidity level data outside of the refrigerated transport unit; transport refrigeration system set-point data; and transport refrigeration system alarm notification data.
6. The remote monitoring system of aspects 1-5, wherein the transport refrigeration system generator set further includes:

a transport refrigeration unit remote monitoring device configured to receive the transport refrigeration unit telemetry data from the transport refrigeration system controller; and

a generator set remote monitoring device configured to obtain generator set telemetry data and configured to combine the transport refrigeration unit telemetry data with the generator set telemetry data to obtain transport refrigeration system telemetry data;

wherein the generator set controller is configured to control the transport refrigeration unit remote monitoring device and the generator set remote monitoring device.

7. The remote monitoring system of aspect 6, wherein the generator set controller is configured to communicate the transport refrigeration system telemetry data to an external server.
8. The remote monitoring system of aspects 6-7, wherein the generator set telemetry data includes one or more of: geographical location data of the refrigerated transport unit; fuel level data of the transport refrigeration system generator set; engine speed data of an engine of the transport refrigeration system generator set; alarm notification data of the transport refrigeration system generator set; and operating time data of the transport refrigeration system generator set.
9. A generator set for powering a transport refrigeration unit of a refrigerated transport unit comprising:

a power generator configured to generate power and provide said power to the transport refrigeration unit, and

a generator set controller configured to control the power generator;

wherein the generator set is configured to receive transport refrigeration unit telemetry data from a transport refrigeration system controller of the transport refrigeration unit.

10. The generator set of aspect 9, wherein the generator set controller is configured to communicate transport refrigeration unit telemetry data to an external server.
11. The generator set of aspects 9-10, wherein the generator set is directly coupled to the transport refrigeration system controller via a wired powerline communication link, and the generator set is configured to receive the transport refrigeration unit telemetry data from the transport refrigeration system controller via the wired powerline communication link.
12. The generator set of aspects 9-11, wherein the generator set is coupled to the transport refrigeration system controller via a wireless communication link, and

the generator set is configured to receive the transport refrigeration unit telemetry data from the transport refrigeration system controller via the wireless communication link.

13. The generator set of aspects 9-12, wherein the transport refrigeration unit telemetry data includes one or more of: refrigerated transport unit temperature data; ambient temperature data; humidity level data within the refrigerated transport unit; humidity level data outside of the refrigerated transport unit; transport refrigeration system set-point data; and transport refrigeration system alarm notification data.
14. The generator set of aspects 9-13, further comprising:

a transport refrigeration unit remote monitoring device configured to receive the transport refrigeration unit telemetry data from the transport refrigeration system controller; and

a generator set remote monitoring device configured to obtain generator set telemetry data and configured to combine the transport refrigeration unit telemetry data with the generator set telemetry data to obtain transport refrigeration system telemetry data;

wherein the generator set controller is configured to control the transport refrigeration unit remote monitoring device and the generator set remote monitoring device.

15. The generator set of aspect 14, wherein the generator set controller is configured to communicate the transport refrigeration system telemetry data to an external server.
16. The generator set of aspects 14-15, wherein the generator set telemetry data includes one or more of: geographical location data of the refrigerated transport unit; fuel level data of the transport refrigeration system generator set; engine speed data of an engine of the transport refrigeration system generator set; alarm notification data of the transport refrigeration system generator set; and operating time data of the transport refrigeration system generator set.
17. A method for remote monitoring of a transport refrigeration system for a refrigerated transport unit, the method comprising:

a transport refrigeration system controller of a transport refrigeration unit obtaining transport refrigeration system telemetry data;

the transport refrigeration system controller sending the transport refrigeration system telemetry data to a generator set configured to power the transport refrigeration unit; and

the generator set receiving the transport refrigeration system telemetry data from the transport refrigeration system controller.

18. The method of aspect 17, further comprising:

the generator set sending the transport refrigeration system telemetry data to an external server.

19. The method of aspects 17-18, further comprising:

a transport refrigeration unit remote monitoring device of the generator set receiving the transport refrigeration unit telemetry data from the transport refrigeration system controller;

a generator set remote monitoring device of the generator set obtaining generator set telemetry data; and

the generator set remote monitoring device combining the transport refrigeration unit telemetry data with the generator set telemetry data to obtain transport refrigeration system telemetry data.

20. The method of aspects 17-20, wherein the transport refrigeration unit telemetry data includes one or more of: refrigerated transport unit temperature data; ambient temperature data; humidity level data within the refrigerated transport unit; humidity level data outside of the refrigerated transport unit; transport refrigeration system set-point data; and transport refrigeration system alarm notification data.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What claimed is:

1. A remote monitoring system for a transport refrigeration system of a refrigerated transport unit comprising:
a transport refrigeration unit that includes:
a refrigeration circuit configured to cool an interior space of the refrigerated transport unit, and
a transport refrigeration system controller configured to control the refrigeration circuit and to obtain transport refrigeration unit telemetry data; and
the transport refrigeration system generator set includes:
a power generator configured to generate power and provide said power to the transport refrigeration unit, and
a generator set controller configured to control the power generator;
wherein the transport refrigeration system generator set is configured to receive transport refrigeration unit telemetry data sent from the transport refrigeration system controller.

2. The remote monitoring system of claim 1, wherein the generator set controller is configured to communicate the transport refrigeration unit telemetry data to an external server.

3. The remote monitoring system of claim 1, wherein the transport refrigeration system controller is directly coupled to the transport refrigeration system generator set via a powerline communication link, and
the transport refrigeration system controller is configured to send the transport refrigeration unit telemetry data to the transport refrigeration system generator set via the powerline communication link.

4. The remote monitoring system of claim 1, wherein the transport refrigeration unit further includes a wireless communication module coupled to the transport refrigeration system controller, and
the transport refrigeration system controller is configured to send the transport refrigeration unit telemetry data to the transport refrigeration system generator set via the wireless communication module.

5. The remote monitoring system of claim 1, wherein the transport refrigeration unit telemetry data includes one or more of: refrigerated transport unit temperature data; ambient temperature data; humidity level data within the refrigerated transport unit; humidity level data outside of the refrigerated transport unit; transport refrigeration system set-point data; and transport refrigeration system alarm notification data.

6. The remote monitoring system of claim 1, wherein the transport refrigeration system generator set further includes:
a transport refrigeration unit remote monitoring device configured to receive the transport refrigeration unit telemetry data from the transport refrigeration system controller; and
a generator set remote monitoring device configured to obtain generator set telemetry data and configured to combine the transport refrigeration unit telemetry data with the generator set telemetry data to obtain transport refrigeration system telemetry data;
wherein the generator set controller is configured to control the transport refrigeration unit remote monitoring device and the generator set remote monitoring device.

7. The remote monitoring system of claim 6, wherein the generator set controller is configured to communicate the transport refrigeration system telemetry data to an external server.

8. The remote monitoring system of claim 6, wherein the generator set telemetry data includes one or more of: geographical location data of the refrigerated transport unit; fuel level data of the transport refrigeration system generator set; engine speed data of an engine of the transport refrigeration system generator set; alarm notification data of the transport refrigeration system generator set; and operating time data of the transport refrigeration system generator set.

9. A generator set for powering a transport refrigeration unit of a refrigerated transport unit comprising:
a power generator configured to generate power and provide said power to the transport refrigeration unit, and
a generator set controller configured to control the power generator;
wherein the generator set is configured to receive transport refrigeration unit telemetry data from a transport refrigeration system controller of the transport refrigeration unit.

10. The generator set of claim 9, wherein the generator set controller is configured to communicate transport refrigeration unit telemetry data to an external server.

11. The generator set of claim 9, wherein the generator set is directly coupled to the transport refrigeration system controller via a wired powerline communication link, and the generator set is configured to receive the transport refrigeration unit telemetry data from the transport refrigeration system controller via the wired powerline communication link.

12. The generator set of claim 9, wherein the generator set is coupled to the transport refrigeration system controller via a wireless communication link, and
the generator set is configured to receive the transport refrigeration unit telemetry data from the transport refrigeration system controller via the wireless communication link.

13. The generator set of claim 9, wherein the transport refrigeration unit telemetry data includes one or more of: refrigerated transport unit temperature data; ambient temperature data; humidity level data within the refrigerated transport unit; humidity level data outside of the refrigerated transport unit; transport refrigeration system set-point data; and transport refrigeration system alarm notification data.

14. The generator set of claim 9, further comprising:
a transport refrigeration unit remote monitoring device configured to receive the transport refrigeration unit telemetry data from the transport refrigeration system controller; and
a generator set remote monitoring device configured to obtain generator set telemetry data and configured to combine the transport refrigeration unit telemetry data with the generator set telemetry data to obtain transport refrigeration system telemetry data;
wherein the generator set controller is configured to control the transport refrigeration unit remote monitoring device and the generator set remote monitoring device.

15. The generator set of claim 14, wherein the generator set controller is configured to communicate the transport refrigeration system telemetry data to an external server.

16. The generator set of claim 14, wherein the generator set telemetry data includes one or more of: geographical location data of the refrigerated transport unit; fuel level data of the transport refrigeration system generator set; engine speed data of an engine of the transport refrigeration system generator set; alarm notification data of the transport refrigeration system generator set; and operating time data of the transport refrigeration system generator set.

17. A method for remote monitoring of a transport refrigeration system for a refrigerated transport unit, the method comprising:
a transport refrigeration system controller of a transport refrigeration unit obtaining transport refrigeration system telemetry data;
the transport refrigeration system controller sending the transport refrigeration system telemetry data to a generator set configured to power the transport refrigeration unit; and
the generator set receiving the transport refrigeration system telemetry data from the transport refrigeration system controller.

18. The method of claim 17, further comprising:
the generator set sending the transport refrigeration system telemetry data to an external server.

19. The method of claim 17, further comprising:
a transport refrigeration unit remote monitoring device of the generator set receiving the transport refrigeration unit telemetry data from the transport refrigeration system controller;
a generator set remote monitoring device of the generator set obtaining generator set telemetry data; and
the generator set remote monitoring device combining the transport refrigeration unit telemetry data with the generator set telemetry data to obtain transport refrigeration system telemetry data.

20. The method of claim 17, wherein the transport refrigeration unit telemetry data includes one or more of: refrigerated transport unit temperature data; ambient temperature data; humidity level data within the refrigerated transport unit; humidity level data outside of the refrigerated transport unit; transport refrigeration system set-point data; and transport refrigeration system alarm notification data.
